(19) United States
(12) Patent Application Publication
(10) Pub. No.: US 2014/0109070 A1
(43) Pub. Date: Apr. 17, 2014

(54) SYSTEM AND METHOD FOR CONFIGURABLE ENTRY POINTS GENERATION AND AIDING VALIDATION IN A SOFTWARE APPLICATION

(71) Applicant: Tata Consultancy Services Limited, Mumbai (IN)

(72) Inventors: Ravi MAHAMUNI, Pune (IN); Supriya MANTRY, Pune (IN)

(21) Appl. No.: 14/047,401

(22) Filed: Oct. 7, 2013

(30) Foreign Application Priority Data
Oct. 11, 2012 (IN) 2994/MUM/2012

(51) Int. Cl. G06F 9/44

(52) U.S. Cl. CPC G06F 8/75
USPC 717/157

(57) ABSTRACT

A system, method, and computer-readable storage medium is disclosed for identifying and verifying entry points in a software application. The method may include processing, using a processor, input data for a software application. The processing may include generating one or more call graphs for said software application, identifying one or more root parameters for each of said one or more call graphs, and setting the one or more root parameters as a first set of entry points, and filtering the first set of entry points using a first call length value provided by a user to generate a second set of entry points. The method may further include displaying, using the processor, the second set of entry points along with their respective call graphs.

### CROSS-REFERENCE TO RELATED PATENT APPLICATION

The present application claims priority under 35 U.S.C. §119 to Indian Patent Application No. 2994/MUM/2012, filed Oct. 11, 2012 in the Indian Patent Office. The aforementioned application is incorporated herein by reference in its entirety.

### TECHNICAL FIELD

The present disclosure generally relates to software application code analysis. More particularly, the disclosure relates to techniques for identifying and verifying configurable entry points in a software application.

### BACKGROUND

Any software application can be written by using several languages. Every programmer while writing application program has his own way to write and implement the program objects. Each one of these languages is open to several API's and directives. Many a times there are requirements for maintenance or up gradation of bulky source code. Before deploying any code on the production system or before starting to work on the source code, it may be imperative to assess the code and understand the entry points for the application source code. Also it may be important to review the code from security point of view.

Entry points in the application source code may be the interfacing or entry functions which help to execute the functionality of the software application. There can be several entry points in the application. These entry points can be called either in sequence or concurrently. Entry points may be required for the analysis of certain functionalities of the application and to validate the application exposure. Identification of entry points may help in providing uniform entry and exit criteria for the application.

During security assessment of the software application, entry point identification may be essential. Entry points may provide information to the application and they may hit the database, server, process engine and other components of the application. If these entry points are not secured then they may open possible vulnerabilities to the application.

To identify the application entry points, it may be essential to have application knowledge. Without a skilled knowledgeable person or documentation, it may be hard and/or time consuming process to find out these entry points. Moreover, the entry point's identification by manual inspection may be a time consuming process and it may also result in getting an invalid result. In addition, if entry points are identified by finding uncalled functions, then it might result in huge list of functions which may need to be validated again. Validation of uncalled functions may be very time consuming and tedious process where it may be almost mandatory to study each functionally and extract the required entry point. Also techniques may not be available which could help in verifying that the entry points which are identified are complete or not.

Therefore, there may be need of a system and method which will help the user to identify the entry points for a software application with minimal knowledge of application or in absence of documentation.

### SUMMARY OF THE INVENTION

According to an aspect of the disclosure, a computer-implemented method of identifying and verifying entry points associated with a software application is disclosed. The method may include processing, using a processor, input data for a software application. The processing may include generating one or more call graphs for said software application, identifying one or more root parameters for each of said one or more call graphs, and setting the one or more root parameters as a first set of entry points, and filtering the first set of entry points using a first call length value provided by a user to generate a second set of entry points. The method may further include displaying, using the processor, the second set of entry points along with their respective call graphs.

According to another aspect of the disclosure, a system for identifying and verifying entry points associated with a software application is disclosed. The system may include a memory storing machine-executable instructions and a processor configured to execute the instructions. The processor may be configured to generate one or more call graphs for said software application, identify one or more root parameters for each of said one or more call graphs, set the one or more root parameters as a first set of entry points, and filter the first set of entry points using a first call length value provided by a user to generate a second set of entry points. The system may further include a display module configured to display the second set of entry points along with their respective call graphs.

According to another aspect of the disclosure, a non-transitory computer-readable storage medium storing instructions for enabling a computer to implement a method of identifying and verifying entry points associated with a software application is disclosed. The method may include processing, using a processor, input data for a software application. The processing may include generating one or more call graphs for said software application, identifying one or more root parameters for each of said one or more call graphs, and setting the one or more root parameters as a first set of entry points, and filtering the first set of entry points using a first call length value provided by a user to generate a second set of entry points. The method may further include displaying, using the processor, the second set of entry points along with their respective call graphs.

### BRIEF DESCRIPTION OF DRAWINGS

The accompanying drawings, which are incorporated in and constitute a part of this disclosure, illustrate exemplary embodiments and, together with the description, serve to explain the disclosed principles

FIG. 1 illustrates an exemplary system architecture.

FIG. 2 illustrates an exemplary flow chart showing the steps involved in generating application entry points by utilizing the architecture of FIG. 1.

FIG. 3 illustrates an exemplary computer system and FIG. 4 illustrates an exemplary call graph.

### DETAILED DESCRIPTION

Exemplary embodiments are described with reference to the accompanying drawings. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

One or more components may be described as modules. For example, a module may include self-contained component in a hardware circuit comprising of logical gate, semiconductor device, integrated circuits or any other discrete component. The module may also be a part of any software program executed by any hardware entity for example processor. The implementation of a module as a software program may include a set of logical instructions to be executed by the processor or any other hardware entity. Further a module may be incorporated with the set of instructions or a program via an interface.

The present disclosure relates to a method and system for identifying and verifying one or more configurable entry points associated with a software application. A call graph illustrating a set of entry points may be generated any displayed.

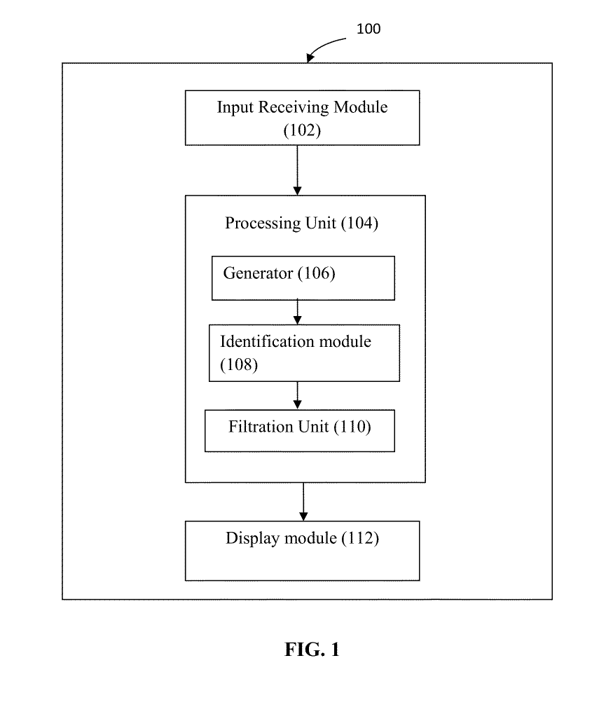

According to FIG. 1, an exemplary system (100) may include an input receiving module (102) configured to accept an input data and a processing unit (104) configured to obtain a comprehensive list of entry points. Processing unit (104) may further include a generator (106), an identification module (108) and a filtration unit (110). System (100) may further include a display module (112) configured to display the filtered set of entry points.

Input receiving module (102) may be configured to receive input data with respect to said software application. The input data may include, but is not limited to, a source code and a call length value. The call length value may include but is not limited to a call depth value.

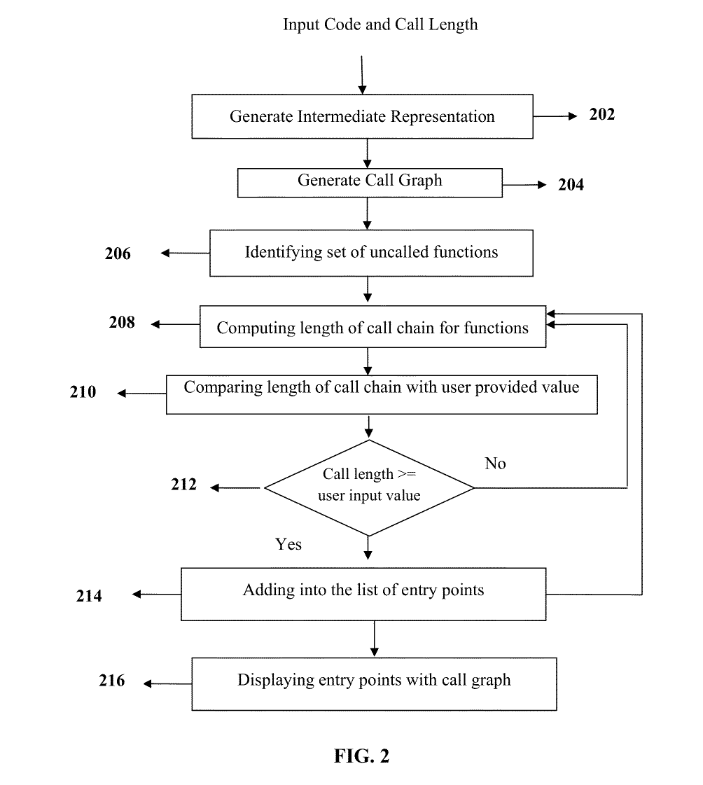

Exemplary operations of system 100 will now be described with reference to FIG. 2. Generator (106) may be configured to generate one or more intermediate representations from a provided or received application source code (step 202). Further by using the one or more intermediate representations one or more call graphs may be constructed (step 204). The call graphs may be displayed in the form of a call hierarchy.

In step 206, identification module (108) may be configured to identify one or more root parameters for the call graph in order to prepare an informative set of entry points. The root parameters may include one or more uncalled functions associated with the call graph. Uncalled functions may act as a super-set of the entry points. Considering the call graph as a graph with incoming and outgoing edges, the incoming edges may represent a function and outgoing edges may represent functions called from this function.

Filtration unit (110) may filter the informative set of entry points by using a pre-decided value provided by the user. The pre-decided value provided by the user may include call length and the call length value may refer to a value of call depth (step 208). Steps 208 and 210 (described next) may allow filtering of a potentially large list of uncalled functions and may make it easy to obtain the required entry points. Thus time consuming process of manually reviewing or sorting the list of uncalled function may be minimized.

Filtration unit (110) may iterate through the super-set of uncalled functions considering one function at a time to determine a call depth or length of call chain for each of the uncalled functions (step 210). The value of the call length/depth for each of the uncalled functions may be compared with the call length/depth value provided by the user (step 212). If the call length/depth value for an uncalled function is greater than the value provided by the user, then the uncalled function may be added to the list of required entry points (step 214). This set of filtered entry points may be displayed by display module (112) and validated with functional knowledge (step 216).

Exemplarily, display module (112) may display the filtered informative set of entry points along with the respective call graph relating to the software application. Thus in order to validate the said set of entry points, visual help may be provided along with call hierarchy. The display module (112) may display the respective call hierarchy for each entry point (step 216). Thus system (100) may provide an integrated automated way to get comprehensive list of entry points and show the call hierarchy. The visualization help presented by system (100) may provide a good knowledge of the entry point and its coverage. A working non-limiting example is provided next that illustrates an application of the above exemplary method.

Let us consider a software application having following functions as source code. We need to get the entry point with the length of call chain=2, which may be provided by the user.

void foo( )
{
bar1( );
bar2( );
}
void bar1( )
{
bar3( );
}
void bar2( )
{
bar3( );
}
voidfunc( )
{
bar2( );
}
void bar3( )
{ }
void func2( )
{
bar3( );
}
void bar4( )
{
}

In the above given sample of code, a call graph (for example, in the form of call hierarchy)may be generated such as the exemplary call graph illustrated in FIG. 4.

Here, the super-set of the entry points (for example, the set of uncalled functions) may be={foo( ), func( ), func2( ), bar4( )}

call chain length of foo( )=2

call chain length of func( )=2

call chain length of func2( )=1

call chain length of bar4( )=0

The required call length is equal to 2.

Hence, set of filtered entry points={foo( ), func( )}

This set of filtered entry points may be displayed along with the respective call hierarchy in order to validate them.

From this list one can select one or more required entry points.

By utilizing the above techniques, entry points for a software application may be identified and verified as per user requirement such as user required minimum call length of functions. In some embodiments, The entry points may be identified and verified without application knowledge or application documentation. The identified entry points may be displayed with respective call hierarchy, so usefulness of entry points can be validated. Time required to review and sort the huge list of uncalled function may be considerably reduced.

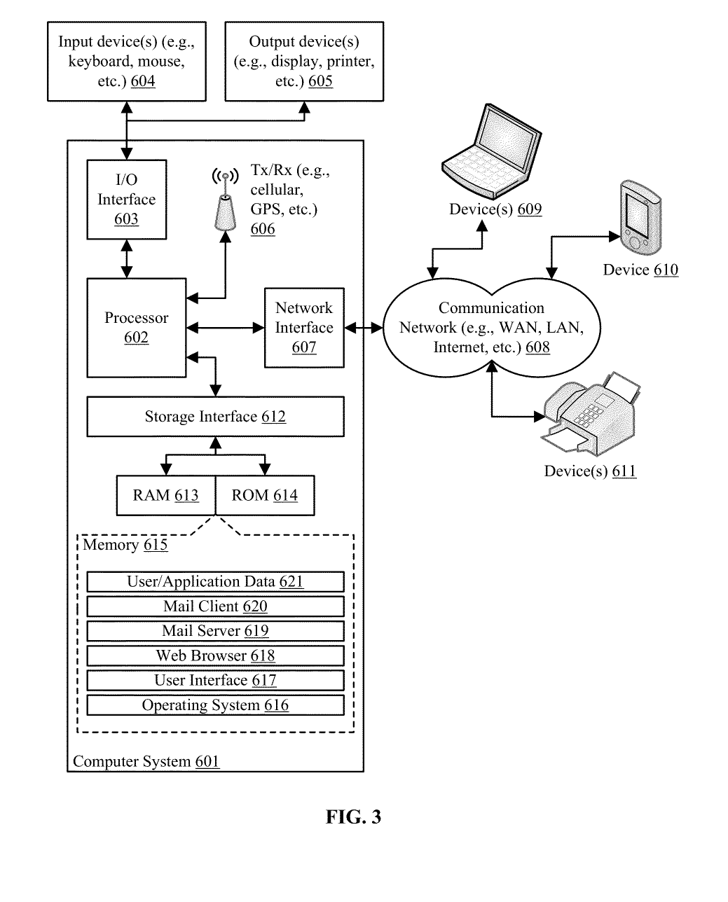

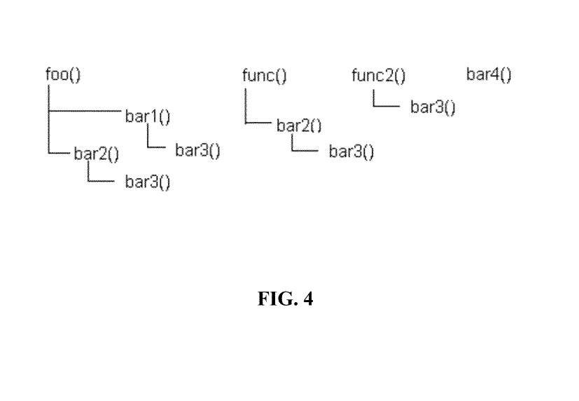

FIG. 3 is a block diagram of an exemplary computer system for implementing embodiments consistent with the present disclosure. Variations of computer system 601 may be used for implementing the devices and algorithms disclosed herein. For example, computer system 601 may implement the system of FIG. 1. Computer system 601 may comprise a central processing unit (“CPU” or “processor”) 602 that may implement the exemplary method FIG. 2. Processor 602 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 610, 611, and 612. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 601 may itself embody one or more of these devices.

In some embodiments, the processor 602 may be disposed in communication with one or more memory devices (e.g., RAM 613, ROM 614, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 601 may implement a web browser 618 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 601 may implement a mail server 619 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as Apple Mail, Microsoft Entourage, Microsoft Outlook, Mozilla Thunderbird, etc.

In some embodiments, computer system 601 may store user/application data 621, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The illustrated steps are set out to explain the exemplary embodiments shown, and it should be anticipated that ongoing technological development may change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A computer-implemented method of identifying and verifying entry points associated with a software application, the method comprising:
processing, using a processor, input data for a software application, the processing including:
generating one or more call graphs for said software application,
identifying one or more root parameters for each of said one or more call graphs,
setting the one or more root parameters as a first set of entry points, and
filtering the first set of entry points using a first call length value provided by a user to generate a second set of entry points, and
displaying, using the processor, the second set of entry points along with their respective call graphs.

2. The method of claim 1, wherein the input data includes a source code of the software application and the first call length.

3. The method of claim 1, wherein the root parameter is an uncalled function in the one or more call graphs.

4. The method of claim 1, wherein the call graph is in a form of call hierarchy.

5. The method of claim 1, wherein the first call length indicates a number of function calls linked to the root parameter of the call graph.

6. The method as claimed in claim 1, wherein filtering the first set of entry points includes identifying a number of function calls linked to the first set of entry points to determine a second call length value for each of the first set of entry points and comparing the second call length value with the first call length value.

7. A system for identifying and verifying entry points associated with a software application, the system comprising:
a memory storing machine-executable instructions;
a processor configured to execute the instructions to:
generate one or more call graphs for said software application,
identify one or more root parameters for each of said one or more call graphs,
set the one or more root parameters as a first set of entry points, and
filter the first set of entry points using a first call length value provided by a user to generate a second set of entry points, and
a display module configured to display the second set of entry points along with their respective call graphs.

8. The system of claim 7, wherein the input data includes a source code of the software application and the first call length.

9. The system of claim 7, wherein the root parameter is an uncalled function in the one or more call graphs.

10. The system of claim 7, wherein the display module is further configured to display the call graph in form of a call hierarchy.

11. The system of claim 7, wherein the processor is configured to filter the first set of entry points by identifying a number of function calls linked to the first set of entry points to determine a second call length value for each of the first set of entry points and comparing the second call length value with the first call length value.

12. The system of claim 1, wherein the first call length indicates a number of function calls linked to the root parameter of the call graph.

13. A non-transitory computer-readable storage medium storing instructions for enabling a computer to implement a method of identifying and verifying entry points associated with a software application, the method comprising:
processing input data for a software application, the processing including:
generating one or more call graphs for said software application,
identifying one or more root parameters for each of said one or more call graphs,
setting the one or more root parameters as a first set of entry points, and
filtering the first set of entry points using a first call length value provided by a user to generate a second set of entry points, and
displaying the second set of entry points along with their respective call graphs.

14. The non-transitory computer-readable storage medium of claim 13, wherein the input data includes a source code of the software application and the first call length.

15. The non-transitory computer-readable storage medium of claim 13, wherein the root parameter is an uncalled function in the one or more call graphs.

16. The non-transitory computer-readable storage medium of claim 13, wherein the call graph is in a form of call hierarchy.

17. The non-transitory computer-readable storage medium of claim 13, wherein the first call length indicates a number of function calls linked to the root parameter of the call graph.

18. The non-transitory computer-readable storage medium of claim 13, wherein filtering the first set of entry points includes identifying a number of function calls linked to the first set of entry points to determine a second call length value for each of the first set of entry points and comparing the second call length value with the first call length value.
